(19) United States
(12) Patent Application Publication
(10) Pub. No.: US 2025/0192373 A1
(43) Pub. Date: Jun. 12, 2025

(54) BATTERY

(71) Applicant: MURATA MANUFACTURING CO., LTD., Kyoto (JP)

(72) Inventors: Kenta GOTOU, Kyoto (JP); Masatomo TANAKA, Kyoto (JP); Kazuhiko MORIZAWA, Kyoto (JP); Tetsuya OSAKA, Kyoto (JP)

(21) Appl. No.: 19/055,982

(22) Filed: Feb. 18, 2025

Related U.S. Application Data
(63) Continuation of application No. PCT/JP2023/037445, filed on Oct. 16, 2023.

(30) Foreign Application Priority Data
Oct. 21, 2022 (JP) 2022-169415

(51) Int. Cl. H01M 50/494; H01M 50/46; H01M 50/463

(52) U.S. Cl. CPC H01M 50/494; H01M 50/46; H01M 50/463

(57) ABSTRACT

A short circuit between a positive electrode and a negative electrode when a separator is damaged by an external force is suppressed. A battery includes an electrode assembly having a positive electrode, a negative electrode, and a film-shaped separator, the electrode assembly has a flat shape, and when a shortest direction of the electrode assembly is defined as a first direction, the separator has a thickness in at least the first direction, and is provided between the positive electrode and the negative electrode at least in the first direction. When a direction in which a distance between sides of the separator facing each other is minimized in plan view in the first direction is defined as a second direction, and a direction perpendicular to the first direction and the second direction is defined as a third direction, an angle formed between the direction in which the tensile strength of the separator is minimized and the second direction is larger than an angle formed between the direction in which the tensile strength of the separator is minimized and the third direction in plan view in the first direction. In plan view in the first direction, a ratio of a length of the separator in the third direction to a length of the separator in the second direction is 2.0 or more.

### CROSS REFERENCE TO RELATED APPLICATIONS

The present application is a continuation of PCT patent application no. PCT/JP2023/037445, filed on Oct. 16, 2023, which claims priority to Japanese patent application no. 2022-169415, filed on Oct. 21, 2022, the entire contents of which are incorporated herein by reference.

### BACKGROUND

The present disclosure relates to a battery.

In a battery, a film-shaped separator formed by stretching in a uniaxial direction may be provided between a positive electrode and a negative electrode. The film-shaped separator has a machine direction (MD) that is a stretching direction and a transverse direction (TD) that is a direction perpendicular to the stretching direction.

A secondary battery is described in which the short direction of the battery and the TD of the separator are the same.

A secondary battery is described in which a TD of a separator is along a lateral direction of a container can in plan view in a laminating direction of the separator for the purpose of suppressing a short circuit due to contact between a positive electrode and a negative electrode due to thermal shrinkage of the separator.

### SUMMARY

The present disclosure relates to a battery.

In the batteries described in the Background section, the short direction of the battery and the TD of the separator are the same. Therefore, when the separator is damaged by an external force, it may not be possible to sufficiently prevent a short circuit between the positive electrode and the negative electrode.

A battery according to an embodiment of the present disclosure is a battery including an electrode assembly having a positive electrode, a negative electrode, and a film-shaped separator, wherein

a shape of the electrode assembly is a flat shape,

when a shortest direction of the electrode assembly is defined as a first direction, the separator has a thickness at least in the first direction, and is provided between the positive electrode and the negative electrode at least in the first direction, when a direction in which a distance between sides of the separator facing each other is minimized in plan view in the first direction is defined as a second direction, and a direction perpendicular to the first direction and the second direction is defined as a third direction, an angle formed between the direction in which the tensile strength of the separator is minimized and the second direction is larger than an angle formed between the direction in which the tensile strength of the separator is minimized and the third direction in plan view in the first direction, and a ratio of a length of the separator in the third direction to a length of the separator in the second direction is 2.0 or more in plan view in the first direction.

The present disclosure, in an embodiment, can suppress a short circuit between the positive electrode and the negative electrode when the separator is damaged by an external force.

### BRIEF DESCRIPTION OF THE FIGURES

FIG. 1 is a cutaway perspective view illustrating an example of a battery according to an embodiment.

FIG. 2 is an exploded plan view illustrating components of the electrode assembly according to an embodiment.

FIG. 3 is a schematic view for explaining a method for measuring tensile strength of a separator.

FIG. 4 is a schematic plan view illustrating the electrode assembly according to an embodiment when the separator is broken.

FIG. 5 is a schematic plan view illustrating a comparative example of the electrode assembly according to FIG. 4.

FIG. 6 is a schematic plan view illustrating an electrode assembly according to a modification example of the battery according to an embodiment.

FIG. 7 is a schematic plan view illustrating a comparative example of the electrode assembly according to FIG. 6.

FIG. 8 is a fragmentary cutaway view illustrating an example of a battery according to an embodiment.

FIG. 9 is a schematic sectional view taken along line IX-IX of FIG. 8.

FIG. 10 is a schematic plan view illustrating an electrode assembly according to an embodiment.

FIG. 11 is a perspective view 11 illustrating an example of a battery according to an embodiment.

FIG. 12 is a sectional view taken along line XII-XII of FIG. 11.

FIG. 13 is a sectional view 13 illustrating a modification example of the battery according to an embodiment.

FIG. 14 is a schematic plan view illustrating batteries according to Examples and Comparative Examples.

FIG. 15 is a schematic sectional view for explaining a piercing test.

FIG. 16 is a view 16 illustrating a result of a tensile test of separators according to Example 1 and Comparative Example 1.

FIG. 17 is a view illustrating a time change in potential difference of a battery during a piercing test according to Example 1.

FIG. 18 is an X-ray CT image of a battery after a piercing test according to Example 1.

FIG. 19 is a view illustrating a time change in potential difference of a battery during a piercing test according to Comparative Example 1.

FIG. 20 is an X-ray CT image of a battery after a piercing test according to Comparative Example 1.

### DETAILED DESCRIPTION

The present disclosure will be described below in further detail including with reference to the figures according to an embodiment. The present disclosure is not limited by the embodiments. Each embodiment is illustrative, and it goes without saying that replacement and combination of a part of configurations illustrated in different embodiments can be performed.

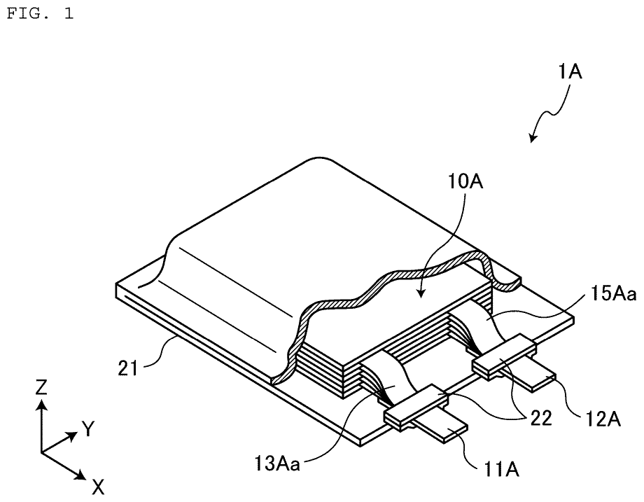

FIG. 1 is a cutaway view illustrating an example of the battery according to a first embodiment. As illustrated in FIG. 1, the battery according to the first embodiment includes a positive electrode lead 11A, a negative electrode lead 12A, an electrode assembly 10A, an exterior member 21, and an adhesive member 22. The battery 1A according to the first embodiment is a so-called laminated lithium ion secondary battery in which the electrode assembly 10A is housed in the exterior member 21.

The positive electrode lead 11A is a terminal extended from the electrode assembly 10 A to the outside of the exterior member 21. That is, the positive electrode lead 11A is a terminal serving as a positive electrode of the battery 1A. The positive electrode lead 11A is provided so as to extend in a direction perpendicular to a Z direction described later. The positive electrode lead 11A includes a conductor.

The negative electrode lead 12A is a terminal drawn out from the electrode assembly 10A to the outside of the exterior member 21. That is, the negative electrode lead 12A is a terminal serving as a negative electrode of the secondary battery 1A. The negative electrode lead 12A is provided so as to extend in a direction perpendicular to a Z direction described later. The negative electrode lead 12A includes a conductor.

The exterior member 21 is a case in which the electrode assembly 10A is accommodated. The exterior member 21 includes an insulating layer, a metal layer, and an outermost layer. The exterior member 21 has a structure in which the insulating layer, the metal layer, and the outermost layer are laminated in this order from the inside, that is, from the side where the electrode assembly 10A is provided, and the layers are bonded by lamination. The insulating layer of the exterior member 21 includes, for example, a resin such as polyethylene, polypropylene, modified polyethylene, modified polypropylene, or a polyolefin resin containing ethylene or propylene as a monomer. As a result, the exterior member 21 can lower the moisture permeability of the battery 1A and improve the airtightness. The metal layer of the exterior member 21 is a metal plate material or foil of aluminum, stainless steel, nickel, iron, or the like. The outermost layer may be any material, but preferably includes a material having high strength, such as a resin similar to that of the insulating layer or nylon. As a result, the exterior member 21 can improve strength against breakage, piercing, and the like.

The adhesive member 22 is a member that makes the inside of the exterior member 21 airtight. The adhesive member 22 is provided so as to surround the positive electrode lead 11A and the negative electrode lead 12A, and seals between the positive electrode lead 11A and the negative electrode lead 12A and the exterior member 21. The material of the adhesive member 22 preferably has adhesion to the positive electrode lead 11A and the negative electrode lead 12A. For example, when the positive electrode lead 11A and the negative electrode lead 12A include a metal material, a polyolefin resin such as polyethylene, polypropylene, modified polyethylene, or modified polypropylene is used as the adhesive member 22. As a result, a gap between the exterior member 21 and the positive electrode lead 11A and the negative electrode lead 12A can be sealed, and thus the interior of the exterior member 21 can be made airtight.

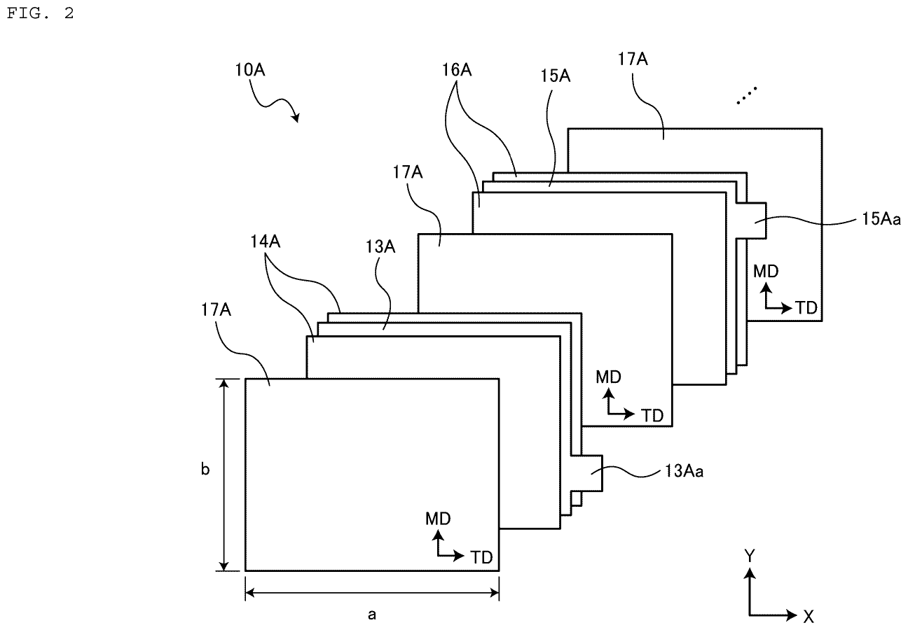

FIG. 2 is an exploded plan view illustrating components of the electrode assembly according to the first embodiment. The electrode assembly 10A includes a positive electrode, a negative electrode, and a separator 17A. As illustrated in FIG. 2, an electrode assembly 10A according to the first embodiment is an electrode laminate in which a positive electrode and a negative electrode are alternately laminated with a separator 17A interposed therebetween. The electrode assembly 10A has a flat shape and a substantially plate shape. The electrode assembly 10A has a substantially rectangular shape. That is, the length of the electrode assembly 10A in one direction is shorter than that in the other direction.

In the following description, the shortest direction of the electrode assembly 10A will be described as the Z direction. In addition, in plan view in the Z direction, a direction in which a distance between sides of the separator 17A to be described later facing each other is minimized will be described as a Y direction, and Y direction to the S direction and the Z direction will be described as an X direction. That is, the electrode assembly 10A has a flat shape spreading in the YZ direction. In the first embodiment, in the electrode assembly 10A, the positive electrode and the negative electrode are laminated, and the separator 17A is laminated in the Z direction. The separator 17A has a thickness in the Z direction, and a length in the X direction is larger than a length in the Y direction in plan view in the Z direction. Details of the shape of the separator 17A will be described later.

The positive electrode includes a positive electrode current collector layer 13A and a positive electrode active material layer 14A. As illustrated in FIG. 2, the positive electrode is a laminate in which the positive electrode active material layer 14A is laminated on both sides of the positive electrode current collector layer 13A in the Z direction.

The positive electrode current collector layer 13A is a sheet-shaped conductor foil, for example, an aluminum foil. In the first embodiment, the positive electrode current collector layer 13A has a rectangular shape having a rectangular protruding portion 13Aa in plan view in the Z direction. The protruding portion 13Aa of the positive electrode current collector layer 13A is connected to the positive electrode lead 11A.

The positive electrode active material layer 14A is a layer including a positive electrode active material. The positive electrode active material layer 14A is laminated so as to sandwich the positive electrode current collector layer 13A therebetween. The positive electrode active material layer 14A includes a positive electrode active material, a conductive agent, and a binder. In the first embodiment, the shape of the positive electrode active material layer 14A is rectangular in plan view in the Z direction. The positive electrode active material layer 14A is not limited to those described above, and may include, for example, a dispersant.

The positive electrode active material is preferably a lithium-containing compound such as a lithium-containing composite oxide or a lithium-containing phosphate compound. The lithium-containing composite oxide is an oxide containing lithium and one or more elements other than lithium as constituent elements. The lithium-containing composite oxide has, for example, a layered rock-salt type or spinel type crystal structure. The lithium-containing phosphate compound is a phosphate compound containing lithium and one or more elements other than lithium as constituent elements. The lithium-containing phosphate compound has, for example, an olivine type crystal structure.

The binder included in the positive electrode active material layer 14A may be any material, and includes, for example, one or more of any of synthetic rubber, a polymer compound, and the like. Examples of the synthetic rubber include styrene-butadiene-based rubber, fluorine-based rubber, and ethylene propylene diene. Examples of the polymer compounds include a polyvinylidene fluoride and a polyimide.

The conductive agent included in the positive electrode active material layer 14A may be any material, and includes, for example, carbon. Examples of the carbon include graphite, carbon black, acetylene black, and Ketjen black. The positive electrode conductive agent is not limited thereto, and may be a metal material, a conductive polymer, or the like as long as the agent is a conductive material.

The negative electrode includes a negative electrode current collector layer 15A and a negative electrode active material layer 16A. As illustrated in FIG. 2, the negative electrode is a laminate in which two layers of the negative electrode active material layers 16A are laminated on both sides of the negative electrode current collector layer 15A in the Z direction.

The negative electrode current collector layer 15A is a sheet-shaped conductor foil, for example, a copper foil. In the first embodiment, the negative electrode current collector layer 15A has a rectangular shape having a rectangular protruding portion 15Aa in plan view in the Z direction. The protruding portion 15Aa of the negative electrode current collector layer 15A is connected to the negative electrode lead 12A.

The negative electrode active material layer 16A is a layer including a negative electrode active material. The negative electrode active material layer 16A may further include a conductive agent and a binder similarly to the positive electrode active material layer 14A.

The negative electrode active material includes, for example, a material capable of occluding and releasing lithium (Li), such as a carbon material, a metal, a metalloid, an alloy or a compound of silicon (Si), or an alloy or a compound of tin (Sn).

Examples of the carbon material that can be used as the negative electrode active material include graphite, non-graphitizable carbon, and graphitizable carbon. More specifically, examples of the carbon material include pyrolytic carbons, cokes, glass-shaped carbon fibers, organic polymer compound fired bodies, activated carbon, and carbon blacks. Examples of the cokes include pitch coke, needle coke, and petroleum coke. The organic polymer compound fired body is a substance obtained by firing a polymer compound such as phenol resin or furan resin at an appropriate temperature to carbonize.

Examples of the metal and the metalloid that can be used as the negative electrode active material include tin, lead (Pb), aluminum, indium (In), silicon, zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Of these, silicon, germanium, tin, and lead are preferable. In addition, silicon and tin are more preferable because of having a high ability to occlude and release lithium and allowing a high energy density.

Examples of the alloy of silicon that can be used as the negative electrode active material include alloys containing at least one from the group consisting of tin, nickel, copper (Cu), iron (Fe), cobalt (Co), manganese (Mn), zinc, indium, silver, titanium (Ti), germanium, bismuth, antimony, and chromium (Cr) as the second constituent element other than silicon. Examples of the compound of silicon that can be used as the negative electrode active material include a compound including oxygen (O) or carbon (C), and the compound may include the above-described second constituent element in addition to silicon.

Examples of the alloy of tin that can be used as the negative electrode active material include alloys including at least one from the group consisting of silicon, nickel, copper, iron, cobalt, manganese, zinc, indium, silver, titanium, germanium, bismuth, antimony, and chromium as the second constituent element other than tin. Examples of the compound of tin that can be used as the negative electrode active material include those including oxygen or carbon, and the compound of tin may include the above-mentioned second constituent elements in addition to tin.

The electrolyte is filled in the exterior member 21. The electrolyte includes an electrolyte salt and a solvent that dissolves this electrolyte salt. Examples of the electrolyte salt include lithium salts such as lithium perchlorate (LiClO₄), lithium hexafluorophosphate (LiPF₆), lithium tetrafluoroborate (LiBF₄), lithium bis (trifluoromethanesulfonyl) imide (LiN (SO₂CF₃)₂), lithium bis (pentafluoroethanesulfonyl) imide (LiN (SO₂C₂F₅)₂), and lithium hexafluoroarsenate (LiAsF₆). Examples of the solvent include non-aqueous solvents including lactone-based solvents such as γ-butyrolactone, γ-valerolactone, δ-valerolactone, and ϵ-caprolactone, carbonate-based solvents such as ethylene carbonate, propylene carbonate, butylene carbonate, vinylene carbonate, dimethyl carbonate, ethyl methyl carbonate, and diethyl carbonate, ether-based solvents such as 1,2-dimethoxyethane, 1-ethoxy-2-methoxyethane, 1,2-diethoxyethane, tetrahydrofuran, and 2-methyltetrahydrofuran, nitrile-based solvents such as acetonitrile, sulfolane-based solvents, phosphoric acids, phosphoric acid ester solvents, and pyrrolidones.

The separator 17A insulates the positive electrode from the negative electrode. The separator 17A is provided such that the positive electrode and the negative electrode are not in direct contact with each other, and is laminated between the positive electrode and the negative electrode in the Z direction in the electrode assembly 10A. As illustrated in FIG. 2, in the first embodiment, a plurality of separators 17A are provided and have a thickness in the Z direction.

In the first embodiment, the separator 17A is rectangular in plan view in the Z direction. That is, the separator 17A has a short side parallel to the Y direction and a long side parallel to the X direction and longer than the short side in plan view in the Z direction. Hereinafter, the length of the separator 17A in the X direction may be described as a, and the length in the Y direction may be described as b. The separator 17A illustrated in FIG. 2 has a right angle at the apex in plan view in the Z direction, but this is merely an example, and the apex may be rounded.

In the first embodiment, the length a of the separator 17A in the X direction is 2.0 times or more the length b in the Y direction. Within this range, when the separator 17A is damaged by an external force, cracks generated in the separator 17A can reach the long side, and thus it is possible to suppress a short circuit between the positive electrode and the negative electrode. The effect of suppressing a short circuit due to a crack generated in the separator 17A will be described later.

The separator 17A includes a material that is electrically stable, chemically stable with respect to the positive electrode active material, the negative electrode active material, and the electrolytic solution, and has an insulating property. As the separator 17A, for example, a layer including a polymer nonwoven fabric, a porous film, glass, or ceramic fibers can be used. In addition, the separator 17A may be a laminate of a plurality of layers, or may be a composite of a porous polyolefin film and a heat-resistant film including polyimide, glass, or ceramic fibers. In addition, the separator 17A may be one in which particles such as ceramic particles are coated on the film surface, but is not limited thereto.

As the separator 17A, a film synthesized by a uniaxial stretching method or a biaxial stretching method is used. The separator 17A preferably includes a film synthesized by a uniaxial stretching method. This can suppress the cost. When a film synthesized by a uniaxial stretching method is used as the separator 17A, the separator 17A is more preferably synthesized by a dry stretching method. This can further suppress the cost.

The separator 17A has a machine direction (MD) and a transverse direction (TD). The MD refers to a flow direction of the film, that is, a direction in which the film travels during manufacturing. The TD refers to a direction perpendicular to MD in plan view in the lateral direction of the film of the separator 17A, that is, the thickness direction. In the uniaxial stretching method, the film is stretched only in the MD. On the other hand, in the biaxial stretching method, the film is stretched not only in the MD but also in the TD.

The MD and TD of the separator 17A can be examined by a scanning electron microscope (SEM) or the like. Specifically, in the SEM observation image of the separator 17A, the direction in which the fibrous structure is oriented can be defined as MD, and the direction perpendicular to the orientation direction and the thickness direction can be defined as TD.

The separator 17A is different in the tensile strength in the MD and the tensile strength in the TD, and has anisotropy in the tensile strength. This is because molecules constituting the separator 17A are oriented in the MD by being stretched in the MD during manufacturing of the separator 17A. Herein, the tensile strength of the separator 17A refers to the maximum tensile stress that the separator 17A can withstand. In the first embodiment, the separator 17A has the maximum tensile strength in the MD and the minimum tensile strength in the TD. That is, in the first embodiment, the direction in which the tensile strength of the separator 17A is minimized is the TD. The anisotropy of the tensile strength of the separator 17A is more strongly exhibited in the film manufactured by the uniaxial stretching method than in the film manufactured by the biaxial stretching method.

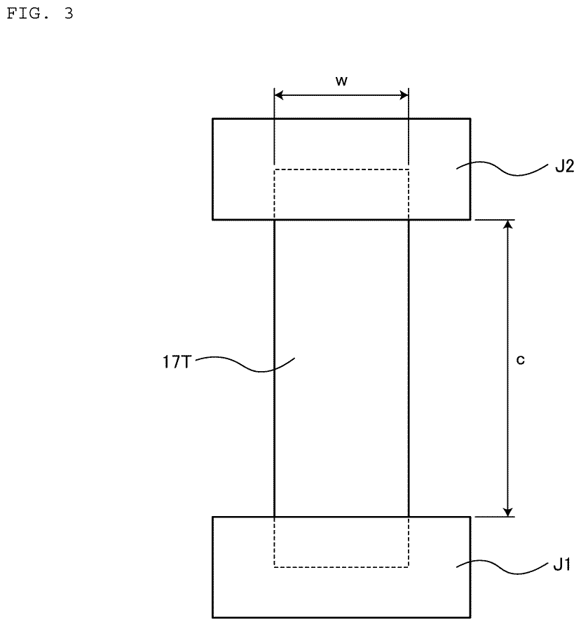

FIG. 3 is a schematic view for explaining a method for measuring tensile strength of a separator. As illustrated in FIG. 3, the tensile strength of the separator 17A can be measured by an Instron universal material testing machine. Specifically, the measurement can be performed by fixing both ends of the test piece 17T of the separator 17A with tensile jigs J1 and J2 and performing a tensile test under the following conditions. Herein, the test piece 17T of the separator 17A is a film used for the separator 17A or a test piece cut out from the separator 17A. In addition, the width w of the test piece 17T refers to the maximum length in the direction perpendicular to the tensile direction of the test piece 17T at the start of the test.
Width w of the test piece 17T: 12.5 mm.
Distance c between tension jigs J1 and J2 of test piece 17T: 30 mm
Tensile speed: 50 mm/min

Herein, the direction in which the tensile strength of the separator 17A is minimized refers to a direction in which the tensile strength of the separator 17A is minimized among directions perpendicular to the thickness direction of the separator 17A. The direction in which the tensile strength of the separator 17A is minimized can be measured by performing the tensile test described above with the direction perpendicular to the thickness direction of the separator 17A as the tensile direction. More specifically, as a result of performing the tensile test with a plurality of directions perpendicular to the thickness direction of the separator 17A as the tensile direction, the direction in which the tensile strength is minimized can be set as the direction in which the tensile strength of the separator 17A is minimized. Herein, the plurality of directions perpendicular to the thickness direction of the separator 17A as the tensile direction in the tensile test includes one direction selected from directions perpendicular to the thickness direction of the separator 17A, a direction perpendicular to the first direction, and a plurality of directions rotated every 5° from the one direction to the perpendicular direction. In other words, the direction in which the tensile strength of the separator 17A is minimized can be determined by performing the tensile test while changing the tensile direction of the separator 17A by 5°.

In the first embodiment, the tensile strength in the MD of the separator 17A is 1.05 times or more the tensile strength in the TD. Within this range, when the separator 17A is damaged by an external force, cracks are generated in the separator 17A in a certain direction, and thus a short circuit between the positive electrode and the negative electrode can be reliably suppressed. Details of the direction of the crack generated in the separator 17A will be described later.

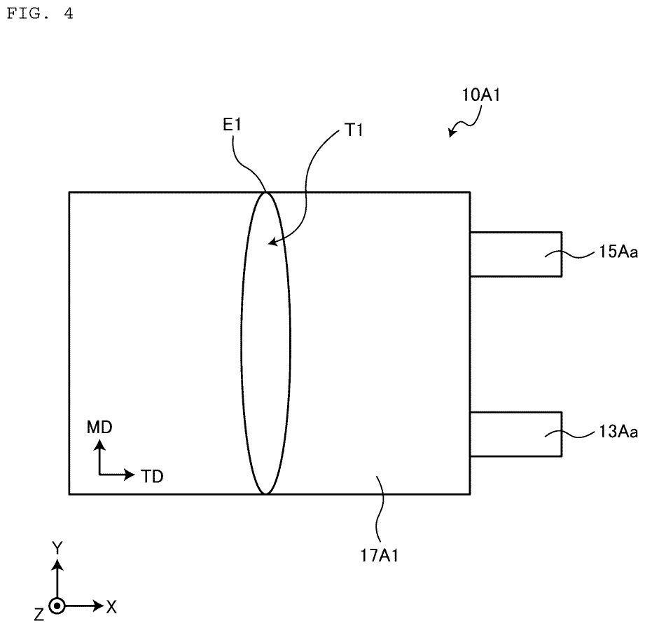

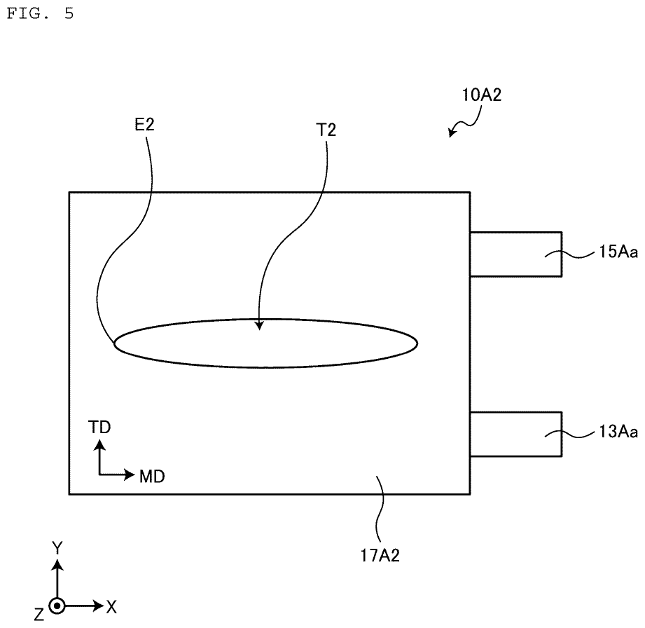

In the first embodiment, the direction in which the tensile strength of the separator 17A is minimized, that is, the TD of the separator 17A is the direction along the X direction. Herein, the direction along the X direction includes a direction that is fully parallel to the X direction and a direction that is substantially parallel to the X direction. The two directions being substantially parallel to each other means that, for example, a size of an angle formed by the two directions is 0° or more and 10° or less. This can suppress a short circuit between the positive electrode and the negative electrode when the separator 17A is damaged by an external force. Hereinafter, this point will be described in detail with reference to FIGS. 4 and 5.

FIG. 4 is a schematic plan view illustrating the electrode assembly according to the first embodiment when the separator is broken. In the electrode assembly 10A1 according to FIG. 4, the TD is the same as the X direction. As illustrated in FIG. 4, when an external force is applied so as to pierce the electrode assembly 10A1 in the Z direction, a crack T1 is generated in the separator 17A1. The crack T1 spreads depending on the anisotropy of the tensile strength of the separator 17A1, and thus the crack T1 spreads in the MD so as to tear the separator 17A1 in the TD in which the tensile strength is weak. In this case, the crack T1 spreads in the lateral direction, that is, the Y direction, and thus the end E1 of the crack T1 reaches the long side of the separator 17A1. Thereby, the positive electrode and the negative electrode are broken together with the separator 17A1 before being in contact with each other in the Z direction, and thus, when the separator 17A1 is damaged by an external force, it is possible to suppress a short circuit between the positive electrode and the negative electrode.

FIG. 5 is a schematic plan view illustrating a comparative example of the electrode assembly according to FIG. 4. In the electrode assembly 10A2 according to FIG. 5, the TD is the same as the Y direction. As illustrated in FIG. 5, when an external force is applied so as to pierce the electrode assembly 10A2 in the Z direction, a crack T2 is generated in the separator 17A2. As in FIG. 4, the crack T2 spreads in the MD such that the crack T2 tears the separator 17A2 in the TD where the tensile strength is weak. In this case, the crack T2 spreads in the longitudinal direction, that is, the X direction, and thus the end E2 of the crack T2 does not reach the short side of the separator 17A2. Thereby, the electrode assembly 10A2 is compressed so as to be ground, and thus the positive electrode and the negative electrode come into contact with each other in the Z direction and are short-circuited.

In the first embodiment, as illustrated in FIG. 2, the TD of the separator 17A, that is, the direction in which the tensile strength is minimized is the same in the plurality of separators 17A. Thereby, when the separator 17 A is damaged by an external force, the crack is likely to spread in the Y direction, and thus it is possible to suppress a short circuit between the positive electrode and the negative electrode.

In the first embodiment, the separators 17A are not welded to each other. Thereby, when the separator 17 A is damaged by an external force, the crack is likely to spread in the Y direction, and thus it is possible to suppress a short circuit between the positive electrode and the negative electrode.

As described above, the battery 1A according to the first embodiment has been described, but the battery according to the first embodiment is not limited to the battery 1A illustrated in FIG. 1.

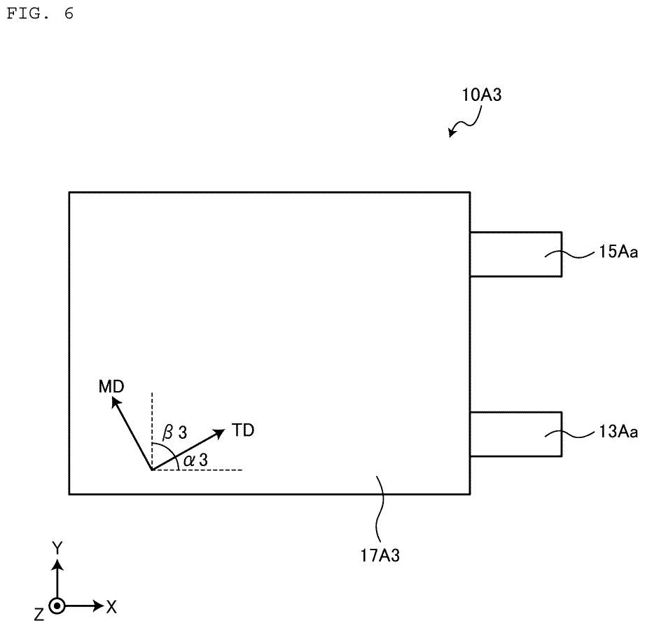

FIG. 6 is a schematic plan view illustrating an electrode assembly according to a modification example of the battery according to the first embodiment. As illustrated in FIG. 6, in the electrode assembly 10A3, the TD of the separator 17A3 may not be in the direction along the X direction in plan view in the Z direction, and an angle β3 formed by the TD of the separator 17A3 and the Y direction may be larger than an angle α3 formed by the TD of the separator 17A3 and the X direction. Even in this case, when the separator 17A3 is damaged by an external force, the crack is likely to reach the long side of the separator 17A3, and the positive electrode and the negative electrode are broken together with the separator 17A3 before being in contact with each other in the Z direction, and thus it is possible to suppress a short circuit between the positive electrode and the negative electrode.

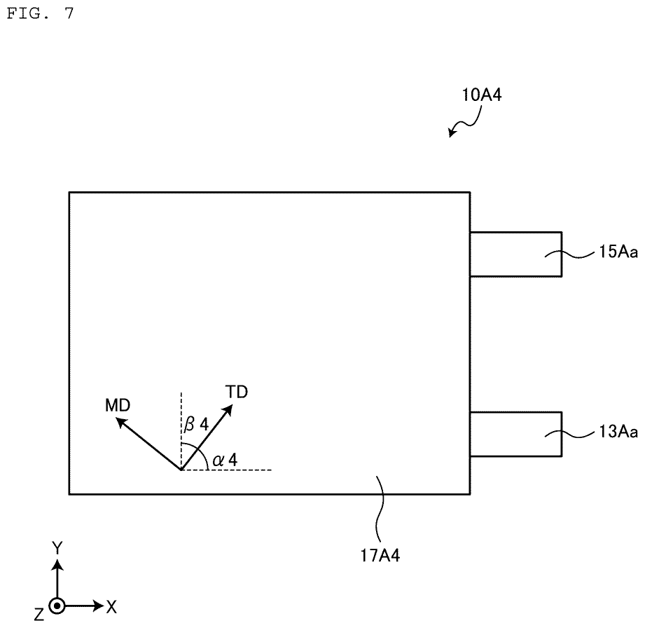

FIG. 7 is a schematic plan view illustrating a comparative example of the electrode assembly according to FIG. 6. As illustrated in FIG. 7, in the electrode assembly 10A4, when the angle β4 formed by the TD of the separator 17A4 and the Y direction is equal to or less than the angle α4 formed by the TD of the separator 17A4 and the X direction in plan view in the Z direction, the crack is less likely to reach the long side of the separator 17A4. Thereby, when the separator 17A4 is damaged by an external force, the electrode assembly 10A4 is compressed so as to be ground, and thus, there is a possibility that the positive electrode and the negative electrode are brought into contact with each other in the Z direction to cause a short circuit.

In addition, in the electrode assembly, a gel-shaped electrolyte layer including a polymer compound that holds an electrolytic solution may be provided instead of the electrolytic solution. In this case, the electrolyte layer is provided between the separator 17A and the positive electrode or the negative electrode. The polymer compound constituting the gel of the electrolyte layer is not particularly limited as long as it absorbs a solvent to become a gel. Examples of the polymer compound constituting the gel of the electrolyte layer include: a fluorine-based polymer compound such as polyvinylidene fluoride or a copolymer of vinylidene fluoride with hexafluoropropylene; an ether-based polymer compound such as polyethylene oxide or a crosslinked product containing polyethylene oxide; and a polymer compound containing polyacrylonitrile, polypropylene oxide, or polymethyl methacrylate as a monomer. The polymer compound constituting the gel of the electrolyte layer is preferably a fluorine-based polymer compound from the viewpoint of stability against oxidation-reduction reaction, and more preferably a copolymer containing vinylidene fluoride and hexafluoropropylene as its components. The copolymer may further contain, as its components, a monoester of an unsaturated dibasic acid such as monomethylmaleic acid ester; ethylene halide such as ethylene trifluoride chloride; a cyclic carbonate ester of an unsaturated compound such as vinylene carbonate; an epoxy group-containing acrylic vinyl monomer; or the like. Thereby, high cycle characteristics can be obtained.

As described above, the battery 1A according to the first embodiment is a battery including an electrode assembly 10A including a positive electrode, a negative electrode, and a film-shaped separator 17A, in which the electrode assembly 10A has a flat shape, and when a shortest direction of the electrode assembly 10A is a first direction, the separator 17A has a thickness in at least a first direction, and is provided between the positive electrode and the negative electrode in at least the first direction, and when a direction in which a distance between sides of the separator 17A facing each other is minimized in plan view in the first direction is a second direction, and a direction perpendicular to the first direction and the second direction is a third direction, an angle formed between a direction (TD) in which tensile strength of the separator 17A is minimized and the second direction in plan view in the first direction is larger than the angle formed between the direction in which the tensile strength of the separator 17A is minimized and the third direction. In plan view in the first direction, a ratio of a length of the separator 17A in the third direction to a length of the separator 17A in the second direction is 2.0 or more.

Thereby, when an external force is applied, the crack T1 spreads in the direction (MD) perpendicular to the direction in which the tensile strength is minimized so as to tear the separator 17A in the direction in which the tensile strength is minimized in plan view in the first direction. The angle formed between the direction (TD) in which the tensile strength of the separator 17A is minimized and the second direction is larger than the angle formed between the direction in which the tensile strength of the separator 17A is minimized and the third direction, and thus the end E1 of the crack T1 is more likely to reach the long side of the separator 17A than the short side of the separator 17A. Thereby, the positive electrode and the negative electrode are broken together with the separator 17A before being in contact with each other in the Z direction, and thus it is possible to suppress a short circuit between the positive electrode and the negative electrode.

As a desirable aspect, the direction in which the tensile strength of the separator 17A is minimized is a direction along the third direction. Thereby, when an external force is applied, the crack T1 spreads in the lateral direction in plan view in the first direction, and thus the end E1 of the crack T1 reliably reaches the long side of the separator 17A. This can more reliably suppress a short circuit between the positive electrode and the negative electrode.

In addition, the separator 17A has a short side parallel to the second direction and a long side parallel to the third direction and longer than the short side in plan view in the first direction. Even in this case, the positive electrode and the negative electrode are broken together with the separator 17A before being in contact with each other in the Z direction, and thus, when the separator 17A is damaged by an external force, it is possible to suppress a short circuit between the positive electrode and the negative electrode.

In addition, the electrode assembly 10A is an electrode laminate in which a positive electrode and a negative electrode are laminated in the first direction with the separator 17A interposed therebetween. Even in this case, the positive electrode and the negative electrode are broken together with the separator 17A before being in contact with each other in the Z direction, and thus, when the separator 17A is damaged by an external force, it is possible to suppress a short circuit between the positive electrode and the negative electrode.

As a desirable aspect, the electrode laminate includes a plurality of separators 17A, and the plurality of separators 17A have the same direction in which the tensile strength is minimized. Thereby, when the separator 17A is damaged by an external force, the crack is likely to spread in a direction perpendicular to the direction in which the tensile strength is minimized, and thus the short circuit between the positive electrode and the negative electrode can be further suppressed.

As a desirable aspect, the ratio of the tensile strength of the separator 17A in the direction (MD) perpendicular to the direction in which the tensile strength of the separator 17A is minimized to the tensile strength of the separator 17A in the direction in which the tensile strength of the separator 17A is minimized is 1.05 or more. Thereby, when the separator 17A is damaged by an external force, the crack occurs in the separator 17A in a certain direction, and thus a short circuit between the positive electrode and the negative electrode can be further suppressed.

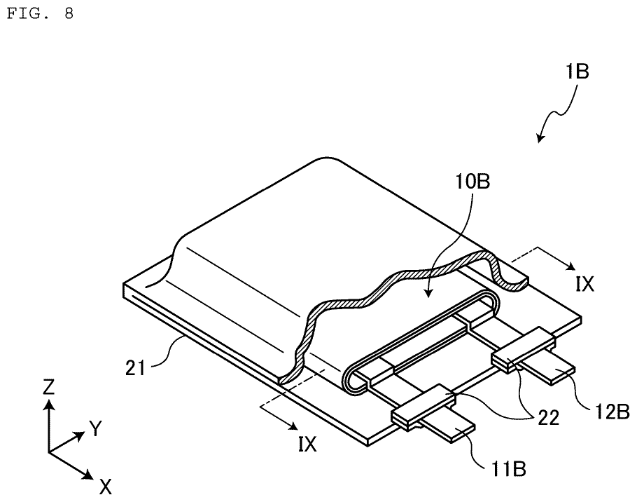

FIG. 8 is a fragmentary cutaway view illustrating an example of a battery according to a second embodiment. As illustrated in FIG. 8, a battery 1B according to the second embodiment is different from that of the first embodiment in that an electrode assembly 10B is an electrode winding body. Hereinafter, the battery 1B according to the second embodiment will be described with reference to the drawings. Description of the same configuration as that of the first embodiment will be omitted.

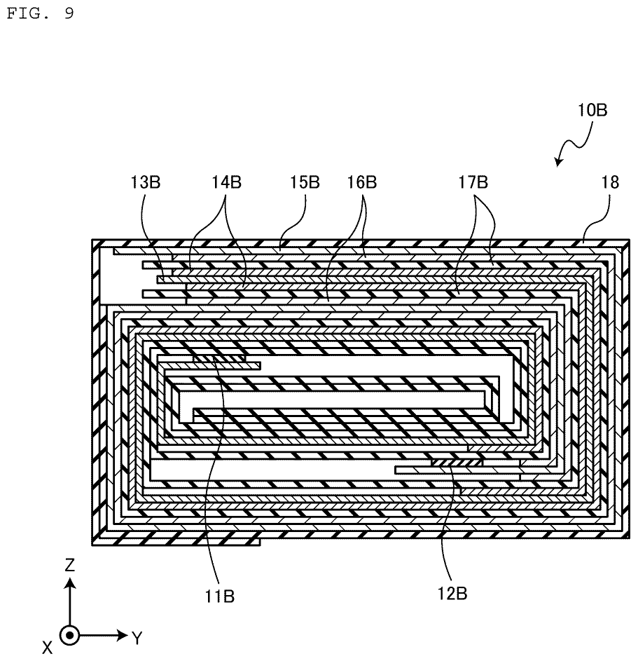

FIG. 9 is a schematic sectional view taken along line IX-IX of FIG. 8. As illustrated in FIG. 9, the electrode assembly 10B according to the second embodiment has a positive electrode including a positive electrode current collector layer 13B and a positive electrode active material layer 14B, a negative electrode including a negative electrode current collector layer 15B and a negative electrode active material layer 16B, a separator 17B, and a protective material 18. As illustrated in FIG. 9, the electrode assembly 10B is an electrode winding body in which a laminate with the positive electrode and the negative electrode laminated with a separator 17B interposed therebetween is wound around a positive electrode lead 11B and a negative electrode lead 12B extending in a direction perpendicular to the Z direction. In the example illustrated in FIG. 9, a laminate including the positive electrode, the negative electrode, and a separator 17B according to the electrode assembly 10B is wound in a direction perpendicular to the X direction. That is, in the electrode assembly 10B, it can be said that the positive electrode, the negative electrode, and the separator 17B are laminated at least in a direction parallel to the Z direction, and the separator 17B has a thickness at least in a direction parallel to the Z direction. The winding direction of the electrode assembly 10B illustrated in FIG. 9 is merely an example, and the electrode assembly may be wound in a direction perpendicular to the Y direction.

The electrode assembly 10B has a flat shape similarly to the electrode assembly 10A according to the first embodiment. That is, the electrode assembly 10B has a plate shape in which the length in the Z direction is shorter than those in the X direction and the Y direction. In other words, the length of the electrode assembly 10B in the direction perpendicular to the winding axis is not constant, and thus the battery 1B is not a so-called cylindrical battery. In the cylindrical battery, a surface perpendicular to the Z direction is a curved surface, and thus if an external force is applied so as to pierce in the Z direction, the crack of the separator does not spread in the MD direction, thus arising a possibility of short circuits of the positive electrode and the negative electrode.

The electrode assembly 10B has a structure in which a negative electrode current collector layer 15B, a negative electrode active material layer 16B, a separator 17B, a positive electrode active material layer 14B, a positive electrode current collector layer 13B, a positive electrode active material layer 14B, a separator 17B, and a negative electrode active material layer 16B are laminated in this order from the outside, that is, from a protective material 18 side. In the electrode assembly 10B, layers other than the negative electrode current collector layer 15B, the separator 17B, and the positive electrode current collector layer 13B are not provided in the vicinity of the positive electrode lead 11B and the negative electrode lead 12B. With this structure, the positive electrode current collector layer 13B is connected to the positive electrode lead 11B, and the negative electrode current collector layer 15B is connected to the negative electrode lead 12B.

The protective material 18 is a member that protects the inside of the electrode assembly 10B. The protective material 18 is provided so as to be wound around the electrode assembly 10B. The protective material 18 is, for example, an insulator tape.

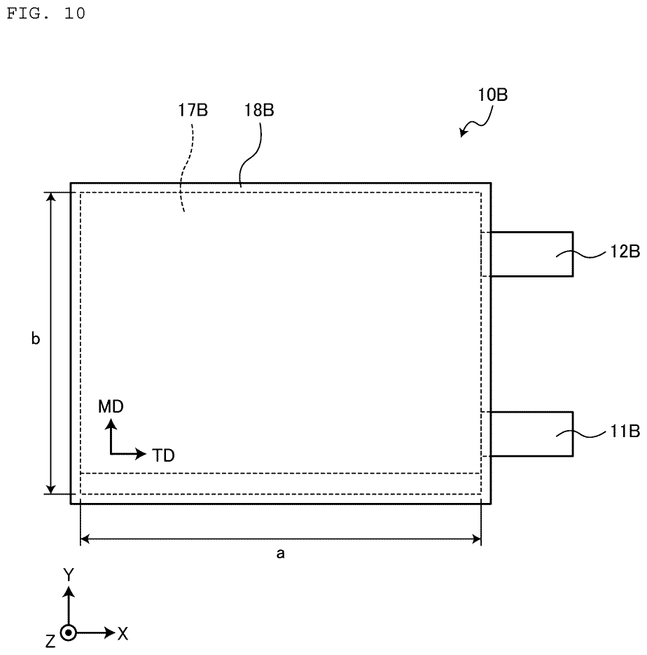

FIG. 10 is a schematic plan view illustrating an electrode assembly according to the second embodiment. As illustrated in FIG. 10, in the second embodiment, the direction in which the tensile strength of the separator 17B is minimized, that is, the TD is a direction along the X direction. Thereby, when the separator 17B is damaged by an external force, the crack generated in the electrode assembly 10B spreads in the lateral direction, that is, the Y direction regardless of the winding direction, and thus the end of the crack reaches the long side of the separator 17B. Thereby, the positive electrode and the negative electrode are broken together with the separator 17B before being in contact with each other in the Z direction, and thus, when the separator 17B is damaged by an external force, it is possible to suppress a short circuit between the positive electrode and the negative electrode.

Although the battery 1B according to the second embodiment has been described above, the battery according to the second embodiment is not limited to the battery 1B illustrated in FIG. 8. For example, in the battery 1B according to the second embodiment, an electrolyte is filled in the inside of the exterior member 21 as in the first embodiment, but is not limited thereto, and instead, a gel-shaped electrolyte layer including a polymer compound that holds an electrolytic solution may be provided. That is, instead of an electrolyte, an electrolyte layer may be provided between the separator 17B and the positive electrode or the negative electrode.

As described above, in the battery according to the second embodiment, the electrode assembly 10B is an electrode winding body in which the positive electrode and the negative electrode are laminated and wound with the separator 17B interposed therebetween. Even in this case, the positive electrode and the negative electrode are broken together with the separator 17B before being in contact with each other in the Z direction, and thus it is possible to suppress a short circuit between the positive electrode and the negative electrode when the separator 17B is broken by an external force.

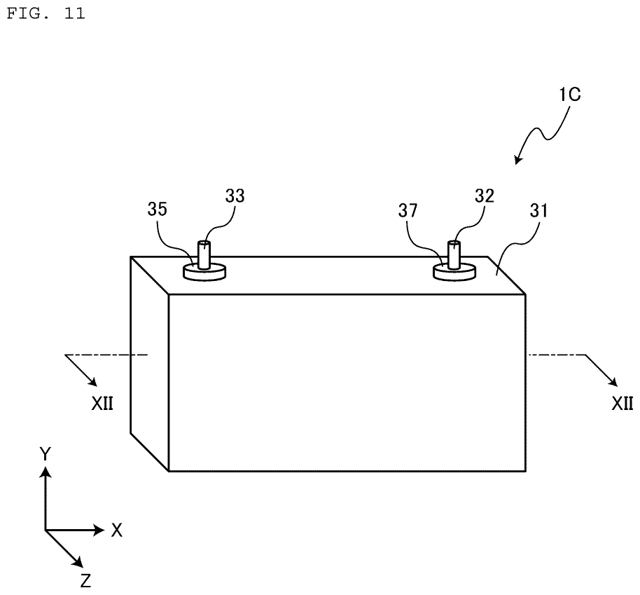

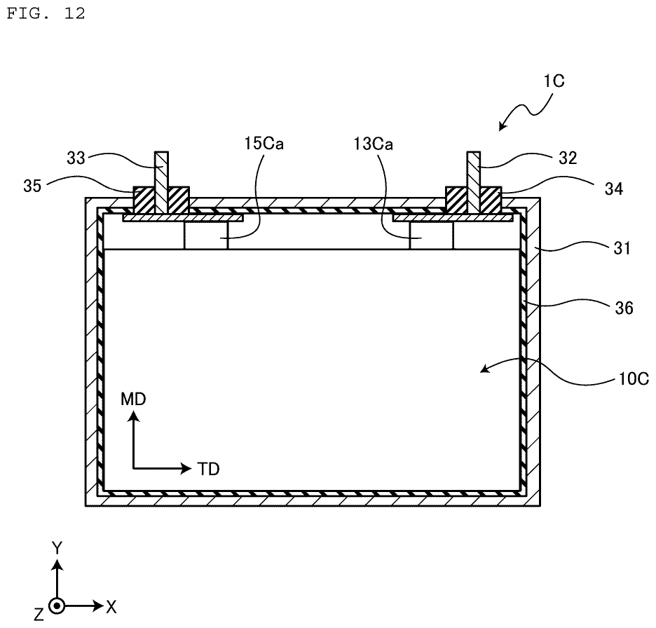

FIG. 11 is a perspective view illustrating an example of a battery according to a third embodiment. FIG. 12 is a sectional view taken along line XII-XII of FIG. 11. As illustrated in FIGS. 11 and 12, a battery 1C according to the third embodiment is different from the first embodiment in that an electrode assembly 10C is housed in a container can 31. That is, the battery 1C according to the third embodiment is a so-called prismatic lithium ion secondary battery. Hereinafter, the battery 1C according to the third embodiment will be described with reference to the drawings. Description of configurations similar to those of the first embodiment and the second embodiment will be omitted.

The battery 1C includes an electrode assembly 10C, a container can 31, electrodes 32 and 33, and sealing materials 34, 35, and 36.

The container can 31 is a can in which the electrode assembly 10C is housed. The container can 31 is a flat rectangular parallelepiped can including a conductor.

The electrode 32 is a terminal drawn out from the inside of the container can 31 to the outside. The electrode 32 is a terminal serving as a positive electrode of the battery 1C. The electrode 32 includes a conductor. The electrode 32 is connected to the protruding portion 13Ca of the positive electrode current collector of the electrode assembly 10C.

The electrode 33 is a terminal drawn out from the inside of the container can 31 to the outside. The electrode 33 is a terminal serving as a negative electrode of the battery 1C. The electrode 33 includes a conductor. The electrode 33 is connected to the protruding portion 15Ca of the negative electrode current collector of the electrode assembly 10C.

The sealing material 34 is provided so as to surround the electrode 32 and seals the inside of the container can 31. The sealing material 34 includes an insulator. This can suppress conduction between the container can 31 and the electrode 32.

The sealing material 35 is provided so as to surround the electrode 33 and seals the inside of the container can 31. The sealing material 35 includes an insulator. This can suppress conduction between the container can 31 and the electrode 33.

The sealing material 36 is provided so as to cover the inside of the container can 31. The sealing material 35 includes an insulator. Thereby, it is possible to suppress conduction between the electrode assembly 10C and the container can 31.

The electrode assembly 10C is an electrode laminate in which a positive electrode and a negative electrode are alternately laminated with a separator interposed therebetween. The electrode assembly 10C is an electrode laminate similar to the electrode assembly 10A according to the first embodiment.

For a separator 17C according to the third embodiment, as in the first embodiment, the direction in which the tensile strength is minimized, that is, the TD is a direction along the X direction in plan view in the Z direction. This can suppress a short circuit between the positive electrode and the negative electrode when the separator is damaged by an external force.

Although the battery 1C according to the third embodiment has been described above, the battery according to the third embodiment is not limited to the battery 1C according to FIG. 12. For example, the electrode assembly may be an electrode winding body.

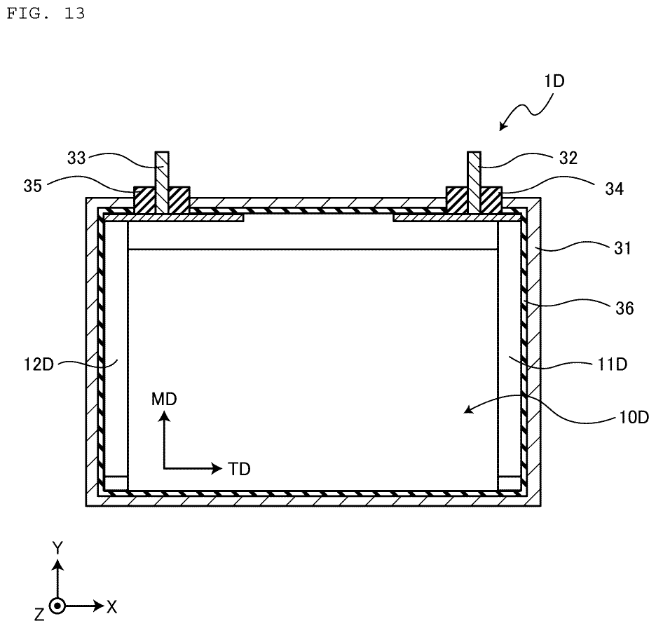

FIG. 13 is a sectional view illustrating a modification example of the battery according to the third embodiment. In a battery 1D according to a modification example of the third embodiment, an electrode assembly 10D is an electrode winding body wound around a positive electrode lead 11D and a negative electrode lead 12D extending in a direction perpendicular to the Z direction.

The positive electrode lead 11D and the negative electrode lead 12D are connected to the electrodes 32 and 33, respectively. The electrode assembly 10D is an electrode winding body having the same configuration as the electrode assembly 10B according to the second embodiment. In the example illustrated in FIG. 13, a laminate including the positive electrode, the negative electrode, and the separator according to the electrode assembly 10D is wound in a direction perpendicular to the X direction. That is, in the electrode assembly 10D, it can be said that the positive electrode, the negative electrode, and the separator are laminated at least in a direction parallel to the Z direction, and the separator 17B has a thickness at least in a direction parallel to the Z direction. In the electrode assembly 10D, as in the first embodiment, for the separator, a direction in which the tensile strength is minimized, that is, the TD is a direction along the X direction in plan view in the Z direction. Therefore, in this case, it is also possible to suppress a short circuit between the positive electrode and the negative electrode when the separator is damaged by an external force. The winding direction of the electrode assembly 10B illustrated in FIG. 13 is merely an example, and the electrode assembly may be wound in a direction perpendicular to the Y direction.

### EXAMPLES

Hereinafter, examples will be described according to an embodiment. The present disclosure is not limited to Examples described below.

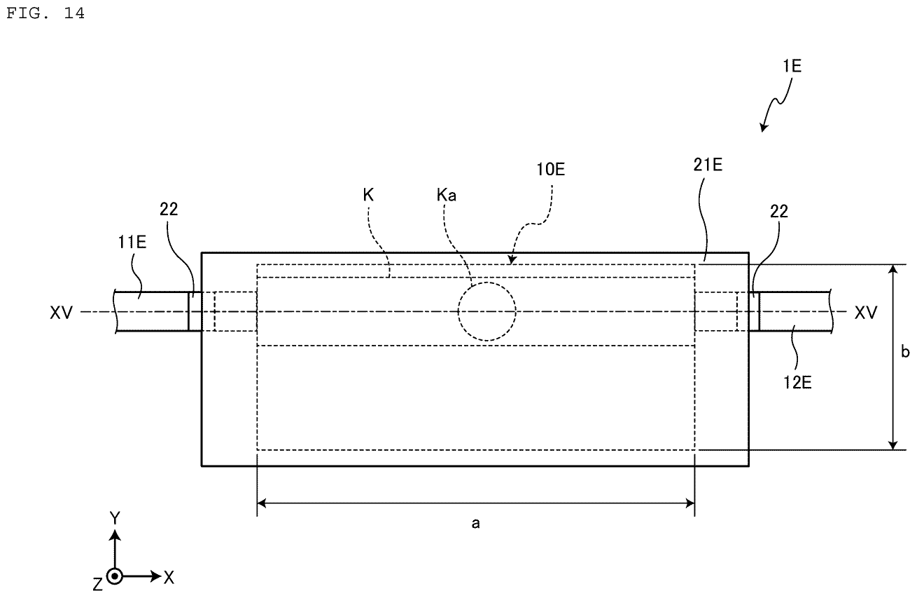

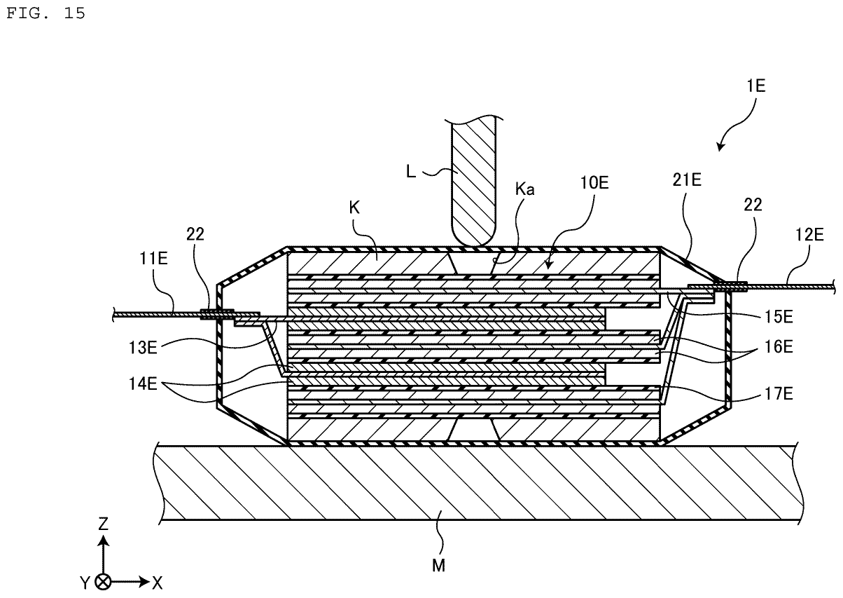

FIG. 14 is a schematic plan view illustrating batteries according to Examples and Comparative Examples. FIG. 15 is a schematic sectional view for explaining a piercing test. In FIG. 15, a battery 1E according to FIG. 14 is illustrated in a sectional taken along line XV-XV in FIG. 14. In the test, the battery 1E illustrated in FIG. 14 and FIG. 15 was produced. The battery 1E is a laminate type battery. That is, as illustrated in FIG. 14 and FIG. 15, the battery 1E includes a positive electrode lead 11E, a negative electrode lead 12E, an electrode assembly 10E, an exterior member 21E, and an adhesive member 22, and the electrode assembly 10E is housed in the exterior member 21E. Herein, the electrode assembly 10E has a structure in which a positive electrode having a positive electrode current collector layer 13E and a positive electrode active material layer 14E and a negative electrode having a negative electrode current collector layer 15E and a negative electrode active material layer 16E are laminated with a separator 17E interposed therebetween.

The separator 17E according to Example 1 and Comparative Example 1 is a porous polyolefin film manufactured by a uniaxial stretching method. The separator 17E has a rectangular shape in plan view in the Z direction, a length a in the X direction is 25 mm, and a length b in the Y direction of the separator 17E is 7 mm. That is, in Example 1 and Comparative Example 1, the length a of the separator 17E in the X direction is 3.5 times the length b of the separator 17E in the Y direction.

Herein, the films used for the separator 17E according to Example 1 and Comparative Example 1 were subjected to a tensile test under the following conditions. The tensile test was performed in the air.
Measuring apparatus: Instron universal material testing machine 5564 (Instron)
Width w of the test piece: 12.5 mm
Distance c between tension jigs of test piece: 30 mm.
Tensile speed: 50 mm/min.
Pulling direction: MD or TD

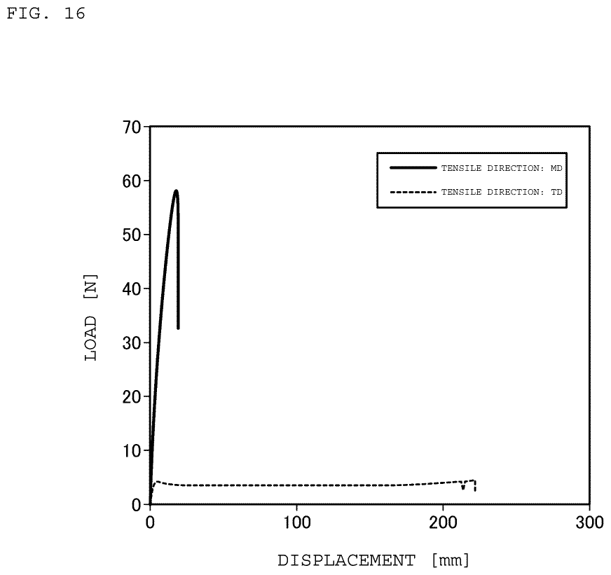

FIG. 16 is a view illustrating a result of a tensile test of separators according to Example 1 and Comparative Example 1. As a result of the tensile test, a load-displacement curve illustrated in FIG. 16 was obtained. In the load-displacement curve of FIG. 16, the maximum value of the load is the tensile strength, and thus it is found that the tensile strength in the MD of the separator 17E is 14 times the tensile strength in the TD.

In the battery 1E, pressing plates K are further provided on both sides in the Z direction of the electrode assembly 10E. The pressing plate K is provided in the exterior member 21E. The pressing plate K is provided with a circular recess Ka having a diameter of 6 mm in plan view in the Z direction at the center in the X direction. The recess Ka is a recess that guides the pin L used for the piercing test to the electrode assembly 10E in the piercing test.

The piercing test was performed on the batteries 1E according to Examples and Comparative Examples described above. As illustrated in FIG. 15, in the piercing test, the pin L was pierced toward the recess Ka of the pressing plate K of the battery 1E on the table M at a speed of 200 mm per second in the Z direction. Herein, the tip of the pin L is a sphere having a diameter of 3 mm. In this case, the presence or absence of a short circuit between the positive electrode and the negative electrode in the battery 1E was examined by measuring the time change in the potential difference between the positive electrode lead 11E and the negative electrode lead 12E before and after piercing. Thereafter, X-ray computed tomography (CT) was performed on the battery 1E to observe a crack generated in the electrode assembly 10E.

In the battery according to Example 1, the TD of all of the separators is in the same direction as the X direction. That is, the TD of all of the separators of the battery according to Example 1 is parallel to the long side of the separator.

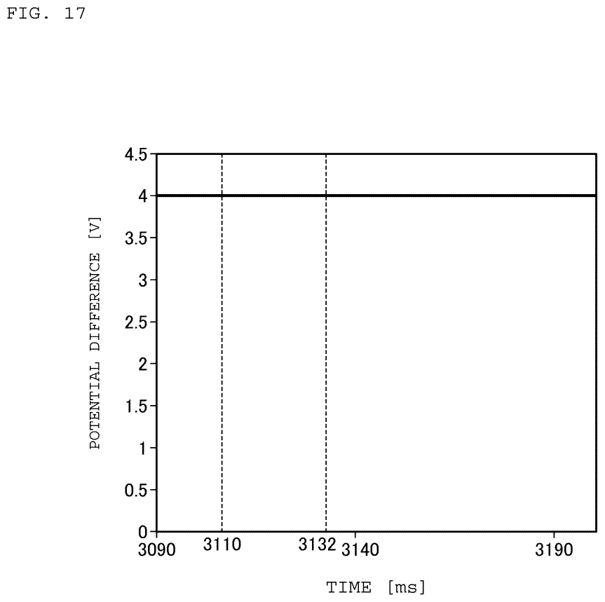

FIG. 17 is a view illustrating a time change in potential difference of the battery during the piercing test according to Example 1. In the piercing test according to Example 1, the pin L and the electrode assembly were in contact with each other at 3110 ms, and the pin L penetrated the electrode assembly at 3132 ms. As illustrated in FIG. 17, in the battery according to Example 1, the potential difference hardly changed before and after piercing. Therefore, in the battery according to Example 1, it is found that the positive electrode and the negative electrode are not short-circuited when an external force is applied in the Z direction.

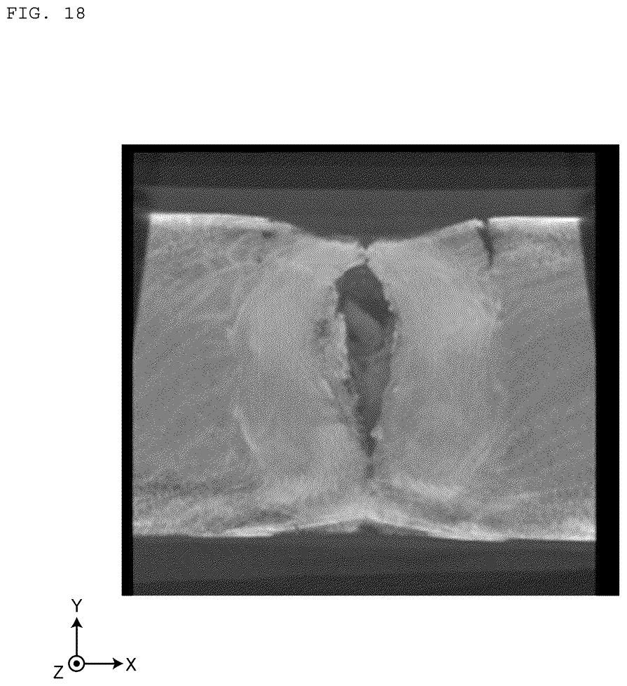

FIG. 18 is an X-ray CT image of a battery after a piercing test according to Example 1. The X-ray CT image according to FIG. 18 is an image obtained by planarly viewing the electrode assembly after the piercing test according to Example 1 in the Z direction. As illustrated in FIG. 18, it is found that the cracks generated in the electrode assembly by the piercing test reach both ends in the Y direction of the electrode assembly. From this, it is considered that the positive electrode and the negative electrode of the electrode assembly were broken together with the separator before being in contact with each other in the Z direction at the time of piercing, and thus the positive electrode and the negative electrode were not short-circuited.

In the battery 1E according to Comparative Example 1, the TD of all of the separators is in the same direction as the Y direction. That is, the TD of all of the separators of the battery 1E according to the example is parallel to the short side of the separator.

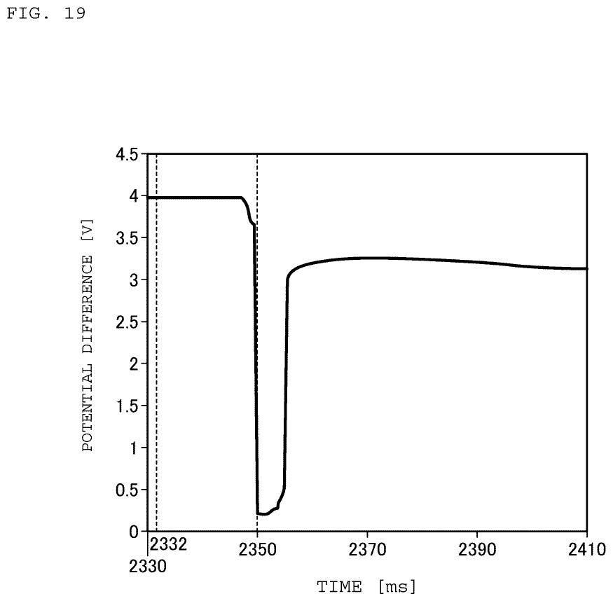

FIG. 19 is a view illustrating a time change in potential difference of a battery during a piercing test according to Comparative Example 1. In the piercing test according to Comparative Example 1, the pin L and the electrode assembly were in contact with each other at 2332 ms, and the pin L penetrated the electrode assembly at 2350 ms. As illustrated in FIG. 19, in the battery according to Comparative Example 1, the potential difference decreased after penetration of the electrode assembly. Therefore, in the battery according to Comparative Example 1, it is found that the positive electrode and the negative electrode are short-circuited when an external force is applied in the Z direction.

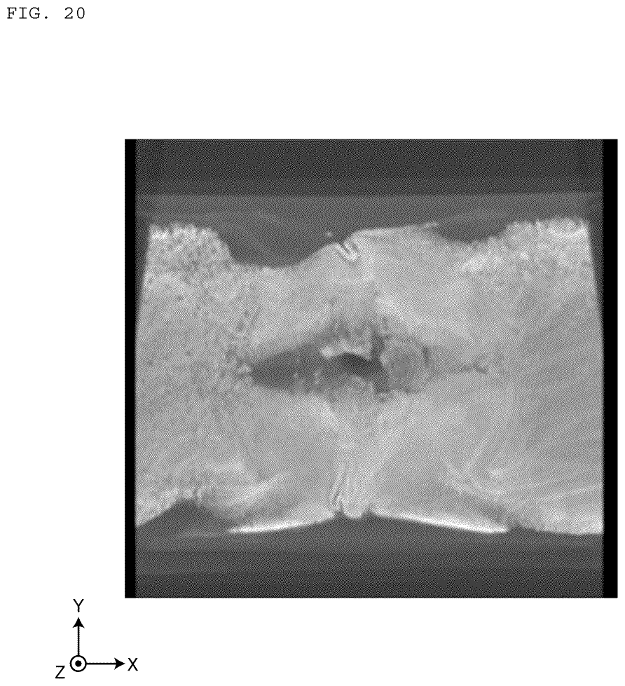

FIG. 20 is an X-ray CT image of a battery after a piercing test according to Comparative Example 1. The X-ray CT image according to FIG. 20 is an image obtained by planarly viewing the electrode assembly after the piercing test according to Comparative Example 1 in the Z direction. As illustrated in FIG. 20, it is found that the cracks generated in the electrode assembly by the piercing test did not reach both ends in the X direction of the electrode assembly. From this, it is considered that the electrode assembly is compressed so as to be ground at the time of piercing, and thus the positive electrode and the negative electrode come into contact with each other in the Z direction, whereby the positive electrode and the negative electrode are short-circuited.

In Example 2, a battery 1E was produced in the same manner as in Example 1 except that the length b of the separator 17E in the Y direction was 12 mm, and a piercing test was performed. That is, in the battery 1E according to Example 2, the TD of all of the separators is in the same direction as the X direction and parallel to the long side of the separator. In addition, in Example 2, the length a of the separator 17E in the X direction is 2.1 times the length b of the separator 17E in the Y direction. In the battery according to Example 2, the potential difference hardly changed before and after piercing. Therefore, in the battery according to Example 2, it is found that the positive electrode and the negative electrode are not short-circuited when an external force is applied in the Z direction.

In Comparative Example 2, a battery 1E was produced in the same manner as in Comparative Example 1 except that the length b of the separator 17E in the Y direction was 12 mm, and a piercing test was performed. That is, in the battery 1E according to Comparative Example 2, the TD of all of the separators is in the same direction as the Y direction and parallel to the short side of the separator. In addition, in Comparative Example 2, the length a of the separator 17E in the X direction is 2.1 times the length b of the separator 17E in the Y direction. In the battery according to Comparative Example 2, the potential difference decreased after the piercing test. Therefore, in the battery according to Comparative Example 2, it is found that the positive electrode and the negative electrode are short-circuited when an external force is applied in the Z direction.

In Comparative Example 3, a battery 1E was produced in the same manner as in Example 1 except that the length b of the separator 17E in the Y direction was 17 mm, and a piercing test was performed. That is, in the battery 1E according to Example 3, the TD of all of the separators is in the same direction as the X direction and parallel to the long side of the separator. In addition, in Comparative Example 3, the length a of the separator 17E in the X direction is 1.5 times the length b of the separator 17E in the Y direction. In the battery according to Comparative Example 3, the potential difference decreased after the piercing test. Therefore, in the battery according to Comparative Example 3, it is found that the positive electrode and the negative electrode are short-circuited when an external force is applied in the Z direction.

From the above results, it is found that in the batteries according to Examples 1 and 2 in which the length a of the separator 17E in the X direction is 2.0 times or more the length b of the separator 17E in the Y direction, a short circuit between the positive electrode and the negative electrode can be suppressed as compared with the battery according to Comparative Example 3 in which the length a of the separator 17E in the X direction is less than 2.0 times the length b of the separator 17E in the Y direction.

It is to be noted that the embodiments described above are intended to facilitate understanding of the present disclosure, but not intended to construe the present disclosure in any limited way. The present disclosure may be modified or improved without departing from the spirit of the present disclosure, and the present disclosure includes equivalents of the present disclosure.

With respect to the description of the claims, the present disclosure may adopt the following aspects according to an embodiment.

(1) A battery including an electrode assembly having a positive electrode, a negative electrode, and a film-shaped separator, wherein

a shape of the electrode assembly is a flat shape,

when a shortest direction of the electrode assembly is defined as a first direction, the separator has a thickness at least in the first direction, and is provided between the positive electrode and the negative electrode at least in the first direction,

when a direction in which a distance between sides of the separator facing each other is minimized in plan view in the first direction is defined as a second direction, and a direction perpendicular to the first direction and the second direction is defined as a third direction, an angle formed between the direction in which the tensile strength of the separator is minimized and the second direction is larger than an angle formed between the direction in which the tensile strength of the separator is minimized and the third direction in plan view in the first direction, and

a ratio of a length of the separator in the third direction to a length of the separator in the second direction is 2.0 or more in plan view in the first direction.

(2) The battery according to (1), wherein the direction in which the tensile strength of the separator is minimized is a direction along the third direction.

(3) The battery according to (1) or (2), wherein the separator has a short side parallel to the second direction and a long side parallel to the third direction and longer than the short side in plan view in the first direction.

(4) The battery according to any one of (1) to (3), wherein the electrode assembly is an electrode laminate in which the positive electrode and the negative electrode are laminated in the first direction with the separator interposed therebetween.

(5) The battery according to (4), wherein the electrode laminate has a plurality of separators, and all the plurality of separators have a same direction in which a tensile strength is minimized.

(6) The battery according to any one of (1) to (3), wherein the electrode assembly is an electrode winding body in which the positive electrode and the negative electrode are laminated and wound with the separator interposed therebetween.

(7) The battery according to any one of (1) to (6), wherein a ratio of a tensile strength of the separator in a direction perpendicular to the direction in which the tensile strength of the separator is minimized to the tensile strength of the separator in the direction in which the tensile strength of the separator is minimized is 1.05 or more.

### DESCRIPTION OF REFERENCE SYMBOLS

1A to 1E: Battery
10A to 10E, 10A1 to 10A4: Electrode assembly
11A, 11B, 11D, 11E: Positive electrode lead
12A, 12B, 12D, 12E: Negative electrode lead
13A, 13B, 13E: Positive electrode current collector layer
13Aa, 13Ca: Protruding portion
14A, 14B, 14E: Positive electrode active material layer
15A, 15B, 15E: Negative electrode current collector layer
15Aa, 15Ca: Protruding portion
16A, 16B, 16E: Negative electrode active material layer
17A, 17B, 17C, 17E, 17A1 to 17A4: Separator
17T: Test piece
18: Protective material
21, 21E: Exterior member
22: Adhesive member
31: Container can
32, 33: Electrode
34, 35, 36: Sealing material
E1, E2: End
J1, J2: Tensile jig
K: Pressing plate
Ka: Recess
L: Pin
M: Base
T1, T2: Crack
w: Width
α3, α4, β3, β4: Angle

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising an electrode assembly comprising a positive electrode, a negative electrode, and a film-shaped separator, wherein
a shape of the electrode assembly is a flat shape,
when a shortest direction of the electrode assembly is defined as a first direction, the separator has a thickness at least in the first direction, and is provided between the positive electrode and the negative electrode at least in the first direction,
when a direction in which a distance between sides of the separator facing each other is minimized in plan view in the first direction is defined as a second direction, and a direction perpendicular to the first direction and the second direction is defined as a third direction, an angle formed between a direction in which a tensile strength of the separator is minimized and the second direction is larger than an angle formed between the direction in which the tensile strength of the separator is minimized and the third direction in plan view in the first direction, and
a ratio of a length of the separator in the third direction to a length of the separator in the second direction is 2.0 or more in plan view in the first direction.

2. The battery according to claim 1, wherein the direction in which the tensile strength of the separator is minimized is a direction along the third direction.

3. The battery according to claim 1, wherein the separator has a short side parallel to the second direction and a long side parallel to the third direction and longer than the short side in plan view in the first direction.

4. The battery according to claim 1, wherein the electrode assembly is an electrode laminate in which the positive electrode and the negative electrode are laminated in the first direction with the separator interposed therebetween.

5. The battery according to claim 4, wherein the electrode laminate has a plurality of separators, and all the plurality of separators have a same direction in which a tensile strength is minimized.

6. The battery according to claim 1, wherein the electrode assembly is an electrode winding body in which the positive electrode and the negative electrode are laminated and wound with the separator interposed therebetween.

7. The battery according to claim 1, wherein a ratio of a tensile strength of the separator in a direction perpendicular to the direction in which the tensile strength of the separator is minimized to the tensile strength of the separator in the direction in which the tensile strength of the separator is minimized is 1.05 or more.
